(19) United States
(12) Patent Application Publication
(10) Pub. No.: US 2023/0404216 A1
(43) Pub. Date: Dec. 21, 2023

(54) Footwear and Apparatus and Method for Making Same

(71) Applicant: inStryde, Inc., Winston-Salem, NC (US)

(72) Inventor: Michael John Schmid, Winston-Salem, NC (US)

(21) Appl. No.: 18/457,600

(22) Filed: Aug. 29, 2023

Related U.S. Application Data
(63) Continuation-in-part of application No. 16/851,898, filed on Apr. 17, 2020.

(51) Int. Cl. A43D 1/02; B33Y 50/00; B33Y 80/00

(52) U.S. Cl. CPC A43D 1/02; B33Y 50/00; B33Y 80/00

(57) ABSTRACT

A customized insole can be created using an additive manufacturing process. The insole is customized to a user and their needs, including correction of a gait or posture of the user. The user can repeatedly insert and remove the insole from footwear as needed. A user can provide captured image data of their feet and/or gait and a lattice structure of the insole can be generated based thereon. The insole can include one or more functional zones, with each functional zone having different mechanical properties than another. In this manner, the insole can be customized to the user and their requirements or needs.

### CROSS-REFERENCE TO RELATED APPLICATIONS

This application is a continuation-in-part of pending U.S. patent application Ser. No. 16/851,898, filed Apr. 17, 2020, which claims priority to, and benefit of, U.S. Provisional Patent Application Ser. No. 62/893,579, filed Aug. 29, 2019, and U.S. Provisional Patent Application Ser. No. 62/836,210, filed Apr. 19, 2019. The entire contents of each of the above applications are hereby incorporated by reference.

### BACKGROUND

### 1. Technical Field

The present disclosure relates to footwear and, more specifically, insole designs and compositions and footwear incorporating the insole designs, as well as method and apparatus for making the insole designs and the footwear incorporating same.

### 2. Discussion of Related Art

Traditional footwear insoles are not fully customized for a user. Rather, insoles are designed to group feet into categories that generally fit a wide variety of feet.

Three-dimensional (“3D”) printing technology has been used to limited extent to manufacture portions of footwear. Current 3D printed insoles use 3D printed structure for rigidity, stability, and fit. But current 3D printing technology does not sufficiently address wearer or user comfort. Thus, footwear made with current 3D printing technology typically requires another layer of material to be added, e.g., foam, as a cushion.

Foam is one of many types of materials deployed to enhance insole comfort and is perhaps one of the most versatile and widely used ways to increase comfort. However, despite the broad adoption of foam, conventional approaches to foam design and experimentation still share a same significant limitation. A limitation of foam utilization for footwear is that compression force applied to foam increases linearly, resulting in, e.g., severe design and comfort constraints.

To address the limitations of foam utilization in footwear, closed-cell foams have been developed to enable an increasingly non-linear load-compression response. However, even the use of closed-cell foams has problems, since any increase in compression performance using closed-cell foams comes at a sizeable cost. For example, the closed-cell foams lack breathability. Lacking breathability, the closed-cell foams demonstrate the thermal profile of an insulator which results in foot discomfort due to heat, e.g., caused by lack of airflow.

In addition, currently existing monolithic footwear does not have zones of differing character. Accordingly, some footwear requires fabrication and then assembly of multiple parts of layers in order to attempt varying zones of character or performance in the footwear. As a result, insoles are often thick, and less compliant with the shoe's intended comfort.

What is needed are methods, apparatus, and/or techniques for making comfortable footwear incorporating insoles, and the footwear and insoles made thereby.

### SUMMARY

The technology described herein relates to a shoe insole comprising a base layer and an optional top layer. The base layer comprises functional zones configured according to a user's physiological data, needs, and intended use. The insoles may either partially or wholly be made using additive manufacturing techniques.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is side, top perspective view of footwear according to an example embodiment.

FIG. 2 is a side top perspective view of an insole of a type utilizable in the footwear of FIG. 1.

FIG. 3A is a top, side, rear perspective view of an insole base layer.

FIG. 3B is a top, side, rear perspective view of an insole top layer.

FIG. 4A is a top plan view of an example insole.

FIG. 4B is a bottom plan view of the example insole of FIG. 4A.

FIG. 4C is an enlargement of a portion of FIG. 4B.

FIG. 5 is a diagrammatic view of an example stochastic structure that may form at least one zone of an insole base layer according to an example embodiment and mode.

FIG. 6 is a diagrammatic view of an example auxetic lattice structure that may form at least one zone of an insole base layer according to an example embodiment and mode.

FIG. 7 is a flowchart that shows example, representative acts or steps which may be included in a method of fabricating or making an example embodiment of footwear of the technology disclosed herein.

FIG. 8 is a schematic view of an example embodiment and mode of apparatus which may be employed for fabricating or making footwear according to example modes of the technology disclosed herein, and also shows acts performed by processor circuitry of such apparatus when executing instructions of a computer program product stored on non-transitory tangible media such as in a memory.

FIG. 9 is a diagrammatic view of an example gyroid structure that may form at least one zone of an insole base layer according to an example embodiment and mode.

FIG. 10 is a diagrammatic view of an example Schwartz structure that may form at least one zone of an insole base layer according to an example embodiment and mode.

FIG. 11 is a block diagram of an example custom insole system.

FIG. 12 is a flowchart of an example process of creating a custom insole.

FIG. 13 is a flowchart of an example video analysis process.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

It will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

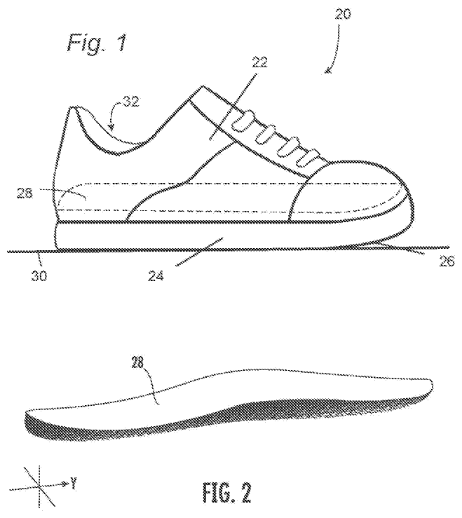

FIG. 1 shows a representative example illustration of an item of footwear 20, e.g., a shoe. In the non-limiting example embodiment of FIG. 1, footwear 20 comprises upper 22; midsole 24; exterior sole or outsole 26; and insole 28. The exterior sole or outsole 26 is configured to interface with a contact surface 30, such as a floor or ground. The upper 22 is attached to the exterior sole 26 and configured to at least partially define a cavity 32 for foot insertion. The insole 28 is insertable into or formed within the cavity 32. Each of these portions can be designed specifically for a user and needs of the user/wearer. As described herein, “footwear” may comprise any combination of upper 22, midsole 24, outsole 26, and insole 28 and therefore need not comprise all portions.

The upper 22 may be the portion of the footwear (such as a shoe) that surrounds the sides and top of a user's foot. The upper 22 may comprise portions, such as a heel support, ankle support, webbing, laces, straps, tongue, and other structures as are known in the art. In some cases, the upper 22 may comprise two or more portions that are selectively bound by a user using, for example, laces or straps.

Insole 28 may be the inner portion of footwear (such as a shoe) that directly contacts the bottom (and to some extent side) of a user's foot. Insole 28 may be a fixed, e.g., permanent, portion of a shoe, or a repeatedly insertable/removable portion of a shoe in different instances. Insole 28 may be designed to improve performance, health, prevent injuries, and relieve foot pressure among other things.

Midsole 24 may be a footwear portion between the insole 28 and the outsole 26, which, in some instances, is a shock-absorbing portion. In some instances, the midsole 24 may be designed to be responsible for supporting a substantial portion of the weight of a user as well as providing shock absorbing properties for the footwear while in use. In other instances, the midsole 24 may be designed to enhance the effectiveness of features found in the insole 28 and/or outsole 26.

Outsole 26 may be the outermost portion of footwear and may be designed to interface with the ground 30. In some instances, the outsole 26 is alternatively known as a tread. The outsole 26 may be designed with, for example, structures and/or textures for providing grip to the footwear on a variety of surfaces. The outsole 26 may also refer to the bottom plate and studs on cleated shoes. Additionally, the outsole 26 may be designed to protect a user's foot from puncture or other harmful intrusion. As with above, the outsole 26 may additionally be designed to enhance the effectiveness of features found in the midsole 24.

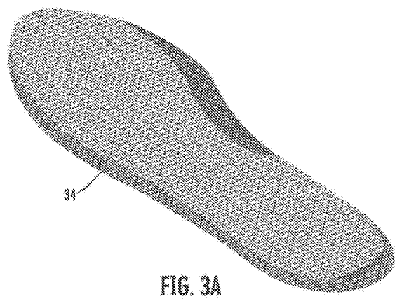

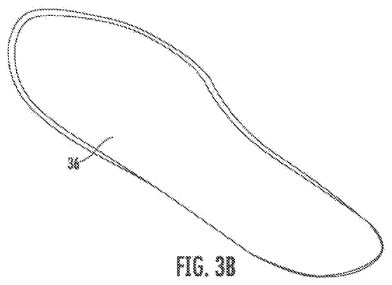

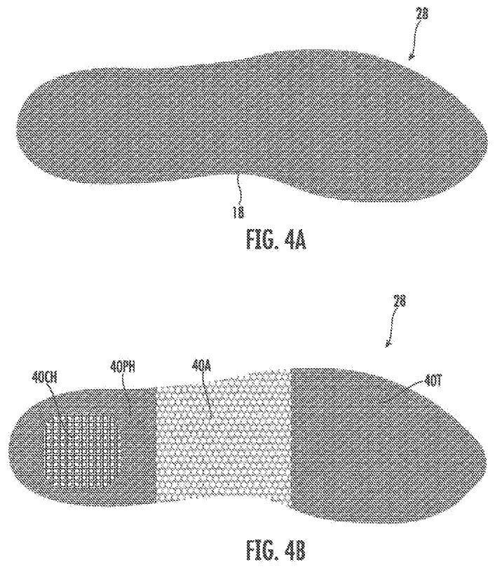

FIG. 2 shows in perspective an example insole 28 as taken out or before insertion in footwear 20. Insole 28 may comprise one or more layers. In some example embodiments and modes insole 28 comprises only one layer, e.g., insole base layer 34 shown in FIG. 3A. In other example embodiments and modes, insole 28 may also comprise insole top layer 36 shown in FIG. 3B. In some example embodiments and modes in which insole 28 comprises two layers, the insole top layer 36 may comprise a suitable material, such as foam, rubber, or fabric which is laid over or affixed to a top of insole base layer 34. The insole top layer 36 may be affixed using any suitable technique, such as adhesive, glue, or hook-and-loop fasteners. The entire insole 28 may have a monolithic construction.

The insole base layer 34 may also be referred to herein as “base layer”; and insole top layer 36 may also be referred to herein as “top layer”. Unless otherwise specified or evident from the context that a top layer of a multi-layer insole 28 is being described, reference herein to “layer” or “layer of insole” or “layer of insole material” is intended to refer to insole base layer 34. Indeed, as indicated above, some embodiments, the insole 28 and its composition may only be one layer, e.g., base layer 34, in which case the insole base layer 34 is synonymous with insole 28.

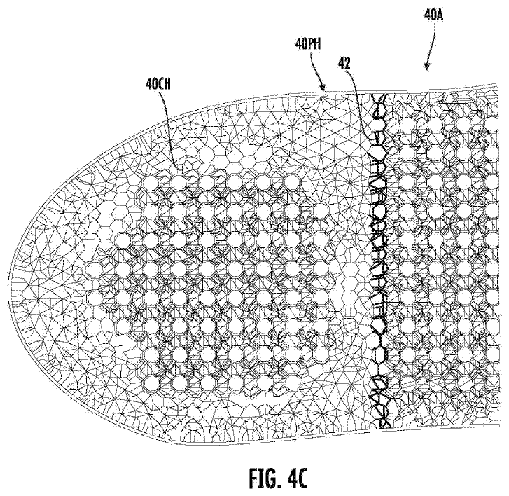

FIG. 4A shows a top plan view of an example insole 28, while FIG. 4B shows a bottom plan view of the example insole 28. FIG. 4B particularly shows that insole 28 comprises at least one layer of insole material which is configured to comprise plural zones 40, also referred to herein as functional zones or structural zones. For example, FIG. 4B shows insole 28 as comprising, by way of non-limiting example, toe zone 40T, arch zone 40A, central heel zone 40CH, and peripheral heel zone 40PH. The insole base layer 34 may thus comprise one or more functional zones 40 all connected within the same insole base layer 34, which layer may be a same monolithic part. Although four zones 40 are shown in FIG. 4B, it should be understood that a difference number of plural zones 40 may comprise insole 28. Moreover, in other example embodiments and modes encompassed hereby, the zones 40 may be differently located and described, such as a central toe zone, a peripheral toe zone, a central arch zone, a peripheral arch zone, a pronation heel zone, a supination heel zone, by way of non-limiting and non-exhaustive examples. As described herein, each zone 40 may be specially and even uniquely configured in terms of zone structure and zone material. Each zone may comprise a material structure which is configured individually for the functional zone.

In an example embodiment and mode, insole base layer 34 is made using additive manufacturing techniques and lattice structures that comprise the multiple zones 40 within a same monolithic part. The functional zones 40 can be tailored to the user's physiological data and intended use. In some embodiments, a functional zone 40 represents a unique compression response within the insole. As mentioned above, insole 28 may have any number of functional zones 40. In some example embodiments, a functional zone may be represented or may be characterized by density, member thickness, or overall thickness of its structure, e.g., lattice structure, in the y direction as shown in FIG. 2 within insole base layer 34. For example, if the heel area requires a certain compression response, and the heel area has a different compression response than the areas adjacent to it, then the heel area is a functional zone. For example, if there is much pressure in the heel area, a certain functional zone can be used and configured to compress a certain amount. Additionally, if there is less pressure in the arch area of the foot and there is a desired compression response, a different functional zone may be configured.

Referring now to FIG. 4C, the lattice structure of a particular functional zone may be varied in the thickness direction to vary the compression response of the functional zone depending on the pressure or the rate of a pressure increase or decrease in the functional zone. As shown, the heel zone includes a first or top structure, a second or middle structure, and a third or bottom structure. The top structure may have first response profile, the middle structure may have a second response profile, and the bottom structure may have a third response profile. The first, second, and third response profiles may each be different from one another. In some embodiments, each of the first, second, and third response profiles may have a compression response and a rebound response that is the same or different from the compression response and/or the rebound response of one of the other response profiles as described in greater detail below.

In terms of material(s), insole base layer 34 with its zones 40 may be manufactured using additive manufacturing techniques, e.g., 3D printing, and made out of a suitable material such as those described herein as being used for additive manufacturing. For example, the insole base layer 34 may be made of a suitable elastomeric, rubber, or plastic material. In some example embodiments, insole base layer 34 may comprise multiple different materials (e.g., elastomeric, rubber, plastic, etc.) strategically placed to improve performance, comfort, and fit among other things. For example, different zones 40 may be formed of different materials. In some embodiments, insole base layer 34 may be manufactured as a single, monolithic part, even in embodiments where insole base layer 34 comprises multiple functional zones 40 within the same part.

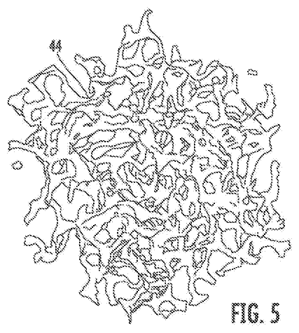

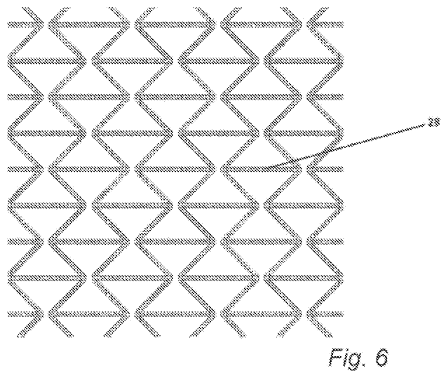

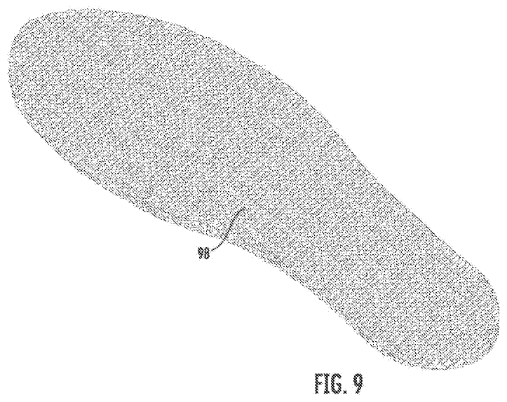

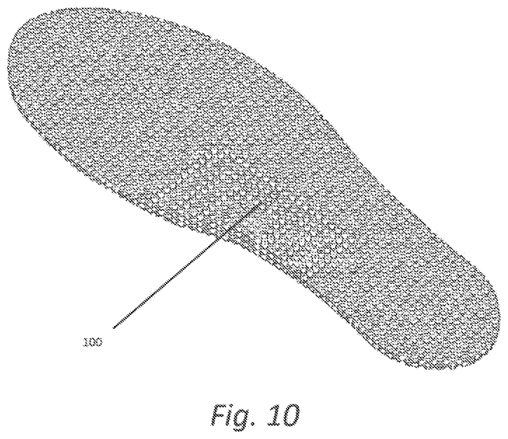

In terms of structure, the zones 40 may include any suitable structure(s), for example, beams, lattices, regular 3D grids, regular or irregular open or closed cell structures, foam or sponge-like formations, trusses, springs, shocks, triclinic structures, monoclinic structures, orthorhombic structures, hexagonal structures, triagonal structures, tetragonal structures, cubic structures, stochastic structures 44 for which an example is shown in FIG. 5, or auxetic lattice structures 46 as shown in FIG. 6, or gyroidal structures 98 as shown in FIG. 9, or Schwartz structures 100 as shown in FIG. 10. Thus, another way to describe a functional zone 40 is with reference to a specific lattice geometry, for example, and without limitation, hex, pillar, or snowflake, that is used to provide a certain compression response. In some example embodiments, insole base layer 34 may comprise multiple functional zones 40 that each may vary in lattice density, lattice type, and may possess a density gradient across one or multiple functional zones 40.

One or more zones 40 may comprise a “unit cell”, which may be replicated through the zone 40. A unit cell may be part of a lattice structure that may be repeated and connected to form a flexible design for insole base layer 34. For example, in some example embodiments and modes, the unit cells of the insole base layer 34 may be designed to be manufactured using the additive manufacturing techniques collectively as one continuous part. In different embodiments, a unit cell may be made in a variety of different shapes and sizes. For example, a unit cell may have a geometric shape, for example, and without limitation, a triangle, square, pentagon, dark horse, snowflake, or icosahedron of a given size. In some example embodiments, the unit cell may be designed to connect to other unit cells, such that a single unit cell may connect to one or more other unit cells. In some example embodiments, the unit cells that make up the base layer can either stay the same or change to help create different functional zones 40 within the same monolithic part. Any type of unit cell may be used at any point within insole base layer 34. For example, a certain pressure profile may require a pentagon unit cell in the heel area and a snowflake unit cell in the arch area to properly support the foot and provide the desired compression response.

The unit cells of the zones 40 can be described as having a lattice construct, including both Triply Periodic Minimal Surface (TPMS) and mass and connector structures. Unit cells of zones 40 may have structures including, but are not limited to, mass and connector structures, regular 3D grids, trusses, triclinic structures, monoclinic structures, orthorhombic structures, hexagonal structures, triagonal structures, tetragonal structures, cubic structures, regular or irregular open or closed cell structures, foam or sponge-like formations, springs, shocks, stochastic structures, and auxetic lattice structures. The unit cells of zones 40 may have Triply Periodic Minimal Surface (TPMS) structures, such as, but not limited to, gyroidal structures and Schwartz structures. The unit cells of zones 40 can also be grouped into categories such as (i) strut-based cellular structures (e.g., Kelvin, Octet-truss, and Gibson-Ashby), (ii) skeletal-TPMS based cellular structures (e.g., Skeletal-IWP, Skeletal-Diamond, Skeletal-Gryoid), and (iii) sheet-TPMS based cellular structures (e.g., Sheet-IWP, Sheet-Diamon, Sheet-Gyroid, and Sheet-Primitive). The foregoing structures are listed by way of example, and not limitation. Any lattice or even non-lattice construct may be used in the structure of unit cells of the zones 40.

From the foregoing it can be seen that the footwear 20 with its insole 28, particularly with insole base layer 34, has many advantages and features. In some example embodiments and modes, for example, the zones 40 may improve any or all of the following: fit, comfort, performance, and may reduce risk of injury for the user, among other things. Furthermore, a functional zone for a lattice structure, such as stochastic structure 44 shown in FIG. 5, may be based on certain compression response ideals for locations within the insole. Additionally, functional zones 40 may influence characteristics of an insole, such as: elasticity, rigidity, compressive energy capacity, and density, among other things. In addition to the form of the functional zone, the position and size of the functional zone may influence the performance of an insole. Further, the lattice structure in insole base layer 34 does not have to be homogeneous in nature. For example, the stiffness at certain points in the lattice structure may vary based off of the user's physiological data and a desired or recommended compression response. The insole base layer 34 may also be constructed by generating a stochastic lattice structure 44 that may vary in density, beam width, and directionality. In some example embodiments, the lattice geometry in insole base layer 34 may be designed to compress a certain amount under certain loads such that the insole does not bottom out, thus conserving energy that is usually lost. In some example embodiments, the lattice geometry in insole base layer 34 may be designed to increase ground force when compressed. In some example embodiments, the lattice structure in insole base layer 34 may be designed to capture compressive and bending forces to conserve energy and increase the user's performance.

In some example embodiments, the lattice structure in insole base layer 34 of the insole 28 has a much higher compressive life cycle when compared to standard foam insoles, thereby allowing for the structural integrity of the insole to last at least the life of the shoe. This allows for insole foot support to deteriorate at a much slower rate.

In some example embodiments, the lattice can provide tune-ability and control throughout the load-compression curve, making it possible to precisely define the transition points between linear elasticity, the plateau, and densification. Alternatively, insole base layer 34 can be designed with portions of auxetic lattice structures 46 as to exhibit a negative Poisson's ratio over specific areas.

In some embodiments, the functional zones may allow for a compression or rebound response to be tuned based on the physiological data of the user. The tuning of the functional zones may allow for a custom orthodic insole for compression and rebound. The tuning of the functional zones may allow for correction of foot pain, improved arch support, correction of plantar fasciitis, correction of flat feet, correction of pronation, or correction of supination.

A three dimensionally printed insole 28 comprising a lattice structure may outperform a traditional shoe insole by delivering a superior performance on compression response control, among other ways. Each unit cell in the lattice structure of the insole may be configured to compress a certain amount based on the user's physiological data, in order to preserve the energy that would normally be lost, among other benefits.

In an example embodiment, the lattice structure in insole base layer 34 may be designed with data collected through a 3D scan of the user's feet allowing for the topology of insole base layer 34 to conform to the user's feet, as well as pressure mapping the user's feet so a desired compression response can be designed into each functional zone 40 of insole base layer 34.

In an example embodiment, insole top layer 36 may be flexible enough to map the topology of the base layer in order to not interfere with the designed fit of the insole.

In an example embodiment, the insole can be designed to fit any shoe or shoe size.

In an example embodiment, insole base layer 34 can be designed for multiple uses such as, but not limited to, walking, standing, running, sprinting, jumping, shuffling, diving, or other activities.

In an example embodiment, insole base layer 34 can be designed for a combination of any type of movement. For example, and without limitation, insole base layer 34 of the insole may be designed for (1) standing and walking, or (2) standing, running, and sprinting, or (3) any other activity or combination of activities.

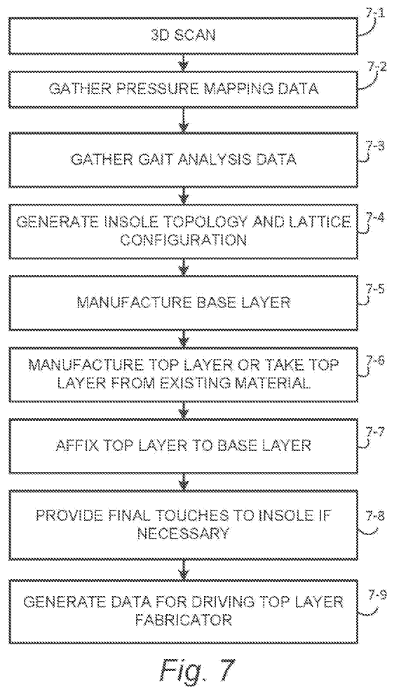

FIG. 7 shows example, representative acts or steps which may be included in a method of fabricating or making an example embodiment of footwear 20 of the technology disclosed herein.

Act 7-1 comprises performing or obtaining a scan, preferably a 3D scan, of the wearer's/user's feet using any type of 3D scanner or apparatus/method for/of converting a 3D object into data that can be viewed on a computing device. Act 7-2 comprises performing or obtaining a pressure map of the user's feet for multiple types of motion, for example, and without limitation, running, jumping, standing, or walking, and collect data. This data can be used to influence the configuration of the lattice structure. Act 7-3 comprises performing a gait analysis or otherwise obtaining gait analysis data that can be used to influence the configuration of the lattice structure. The 3D scanning of act 7-1 and the pressure mapping of act 7-2 may be done at the same time, if desired.

Act 7-4 comprises using the 3D foot scan data obtained as act 7-1, the pressure mapping data obtained as act 7-2, and the gait analysis data obtained as act 7-3 to generate the desired topology, lattice structure, and functional zones 40 of the insole 28. Act 7-5 comprises manufacturing or making the insole base layer 34 by additive manufacturing or other manufacturing means. Act 7-6 comprises manufacturing or making insole top layer 36 by additive manufacturing or other manufacturing means, or cutting material of top layer to the desired shape from a pre-existing material. Act 7-7 comprises affixing insole top layer 36 to insole base layer 34. Act 7-8 comprises providing any desired final touches to insole 28, if necessary, for example, if part of the top layer needs to be trimmed it can be done at this time.

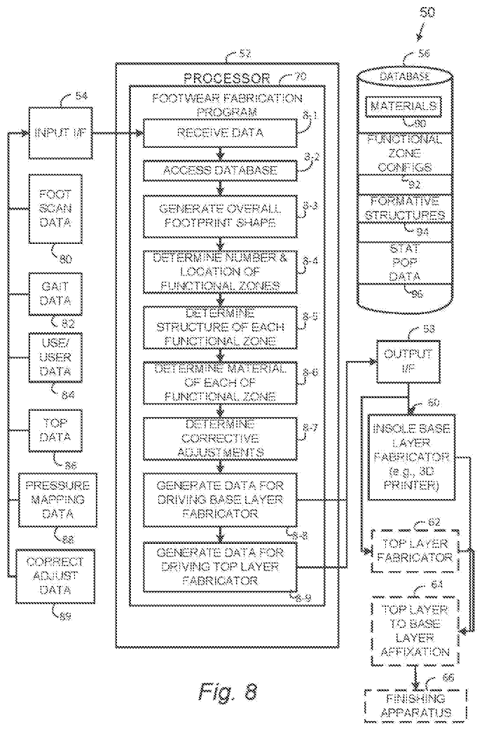

FIG. 8 shows an example embodiment and mode of apparatus 50 which may be employed for fabricating or making footwear according to example modes of the technology disclosed herein. The apparatus of FIG. 8 comprises processor circuitry, generally depicted as processor 52; input interface 54; database or other memory 56; output interface 58; insole base layer fabricator 60; an optional insole top layer fabricator 62; an optional affixation apparatus 64 for affixing insole top layer 36 to insole base layer 34; and, an optional finalization or finishing apparatus 66.

FIG. 8 also shows acts performed by processor circuitry 52 of apparatus 50 when executing instructions of a computer program product stored on non-transitory tangible media such as in memory. The computer program product executed by processor 50 may herein be referred to as footwear fabrication program 70.

In its execution by processor 52, footwear fabrication program 70 may receive various inputs through input interface 54. Among the inputs to input interface 54 shown in FIG. 8 are wearer foot scan data 80; wearer gait data 82; wearer/user or intended use data, e.g., use and user data 84; data describing or pertaining to insole top layer 36, e.g., “top data” 86; wearer foot pressure mapping data 88; and, corrective adjustment data 89. As understood from above, e.g., with reference to act 7-1, the wearer foot scan data 80, preferably a 3D scan, may be procured using any type of 3D scanner or apparatus/method for/of converting a 3D object into data that can be viewed on a computing device. The wearer pressure mapping data 88 may comprise dynamic foot pressure measurements. For example, the dynamic pressures on a user's foot may be measured during dynamic foot activities, such as: running, walking, jumping, landing, pivoting, rolling, rocking, and the like. The wearer pressure mapping data 88 and wearer gait data 82 may be obtained through conventional equipment, either in conjunction with one another and the wearer foot scan data 80 or individually.

The top data 86 may be input as a file which may be created in response to automated or operator response to a menu which requests input or parameters describing the desired or required insole top layer 36.

The use/user data 84 may comprise data regarding a particular user's physical characteristics or attributes-so called “static” user data. For example, a user's foot size and static foot pressure (e.g., when standing) may be measured. The use/user data 84 may also comprise data related to intended use of the footwear 20. Virtually any functional biomechanical measurements may be used during the design of the insole base layer 34.

In its execution by processor 52, footwear fabrication program 70 may also receive various inputs from database 56. Among the database input may be a materials file, e.g., materials 90, which includes information concerning potential materials which may be selected by footwear fabrication program 70 in the configuration of the insole base layer 34, including properties and parameters associated with the respective materials. Another database input may be a file of functional zone configurations 92 which describes various potential patterns of zone combinations, arrangement/location (e.g., central toe zone, a peripheral toe zone, a central arch zone, a peripheral arch zone, a pronation heel zone, a supination heel zone, by way of non-limiting and non-exhaustive examples), and sizes which may be suitable for the insole base layer 34 based on the input applied through input interface 54. A further database input to footwear fabrication program 70 may be a file of formative structures 94 which describes potential zone structures such as, without limitations, beams, lattices, regular 3D grids, regular or irregular open or closed cell structures, foam or sponge-like formations, trusses, springs, shocks, triclinic structures, monoclinic structures, orthorhombic structures, hexagonal structures, triagonal structures, tetragonal structures, cubic structures, stochastic structures, or auxetic lattice structures.

Yet another database input to footwear fabrication program 70 may be a file of statistical population data 96 which may comprise non-user-specific data, such as for example, the average shape of a foot of a certain size may be statistically determined, or otherwise available from existing statistical datasets. Further, the statistical averages for these and other physical foot characteristics may have associated statistical parameters, such as distributions, standard deviations, variances, and others as are known in the art. In this way, knowing a single foot characteristic associated with a user/wearer, such as a shoe size, may enable the use of many associated statistical foot characteristics, e.g., shape, size, etc.

When executed by processor 52, the footwear fabrication program 70 of the example embodiment and mode of FIG. 8 may execute acts such as those shown in FIG. 8. Act 8-1 comprises receiving data input to footwear fabrication program 70 through input interface 54, such as but not necessarily limited to the wearer foot three-dimensional scan data 80, wearer gait data 82, wearer intended use data 84, top data 86, and wearer foot pressure mapping data 88 mentioned above. Act 8-2 comprises accessing the database 56 in order to procure files or information in order to perform at least acts 8-3 through 8-6. In fact, during one or more of the acts 8-3 through 8-6 the database 56 may be accessed or consulted in order to obtain files or information germane to each act.

Act 8-3 of footwear fabrication program 70 comprises generating an overall topology or footprint shape for the insole base layer 34. Act 8-4 comprises determining a number and locations, and sizes, of the plural zones zone 40 which are to comprise or form insole base layer 34.

As an optional aspect, act 8-4 may also comprise determining an interface between adjacent zones, e.g., a zone interface between at least two of the plural functional zones. In an example embodiment and mode, the zone interface may be configured in dependence upon the material structure of adjacent plural functional zones.

Act 8-5 comprises determining a structure for each zone 40. As described above, the structure selected for a zone 40 may be, for example, beams, lattices, regular 3D grids, regular or irregular open or closed cell structures, foam or sponge-like formations, trusses, springs, shocks, triclinic structures, monoclinic structures, orthorhombic structures, hexagonal structures, triagonal structures, tetragonal structures, cubic structures, stochastic structures, or auxetic lattice structures. Act 8-6 comprises determining a material(s) for each zone 40.

The selection and/or determinations of act 8-4 through act 8-6 may be performed through a look up table system wherein combinations of input data received through input interface 54 may be utilized in order to locate an appropriate corresponding insole base layer configuration. For example, an ordered array of input values may match or correspond to a particular insole base layer design which has a pre-stored association of zone configuration (number of zones, locations of zones, and sizes of zones), zone structures, and zone materials. As an alternative to a lookup table approach, the footwear fabrication program 70 may include logic or intelligence for assessing the inputs received through input interface 54 and using certain weights for the input and/or programmed criteria, determine the appropriate parameters of zones, zone materials, and zone structures. It should be understood that the acts 8-4 and 8-6 need not be executed strictly in the order shown, and moreover that one or more of acts 8-4 through 8-6 may be executed essentially concurrently or iteratively in order to optimize the determinations thereof.

Upon completion of execution of act 8-4 through 8-8, footwear fabrication program 70 may generate data for driving base layer fabricator 60 as shown by act 8-8. But as an optional act 8-7 the fabricator driving data footwear fabrication program 70 may determine if any corrective adjustments should be performed for fabrication of insole base layer 34. Act 8-7 and other optional acts or optional equipment are shown by broken lines in FIG. 8. The corrective adjustment act 8-7 may also be executed in an order different than as shown in FIG. 8, or in conjunction or simultaneously with one or more acts 8-4 through 8-6 inclusive. The information 89 pertaining to one or more corrective adjustment(s) may be input to input interface 54 or otherwise. A discussion of various corrective adjustments ensues subsequently. Consideration and processing of corrective adjustment data may cause footwear fabrication program 70 to generated corrective data for driving the insole base layer fabricator 60.

Act 8-8 shows footwear fabrication program 70 generating, as a result and based on execution of previous acts, data for driving the insole base layer fabricator 60. The insole base layer driving data may be output as a file or series of signals to output interface 58, which in turn communicates with the insole base layer fabricator 60. As mentioned above, the insole base layer fabricator 60 may be an additive manufacturing apparatus, such as a three-dimensional printer.

If the insole 28 is designed to include insole top layer 36 in addition to insole base layer 34, as act 8-8 the footwear fabrication program 70 generates data for driving insole top layer fabricator 62. The insole top layer fabricator 62 may also be an additive manufacturing apparatus, or other type of apparatus including an apparatus which selects prefabricated structure from an existing stock of insole top layers. FIG. 8 further reflect operations in which the insole base layer 34 made by insole base layer fabricator 60 and the insole top layer 36 made or selected by insole top layer fabricator 62 is conveyed or directed to affixation apparatus 64. As described above, the affixation apparatus 64 may secure the insole top layer 36 to the underlying insole base layer 34 by any suitable technique, such as, for example, adhesive, glue, hook-and-loop fasteners.

Since the technology disclosed herein is not limited to insoles that comprise both insole base layer 34 and insole top layer 36 but may also be directed to insoles that have only insole base layer 34, act 8-8 is shown as optional in FIG. 8, as is insole top layer fabricator 62 and affixation apparatus 64.

A further optional apparatus is finishing equipment 66 which may perform any polishing, tweaking, trimming, or other type of adjustment to the insole 28, whether it be a multi-layer insole 28 with both insole base layer 34 and insole top layer 36, or an insole 28 having only an insole base layer 34.

As mentioned above, the footwear fabrication program 70 may be configured to implement optional act 8-7 for determining corrective adjustments to the insole 28. Several examples and a discussion of aspects of corrective adjustments or corrective features are now described.

In an example embodiment, the lattice structure in insole base layer 34 may be configured to compensate for certain variables, such as difference in leg length or movement of the foot. For example, the lattice structure for a left leg may be made shorter than the lattice structure for a right leg to compensate for different leg length in individuals. The lattice structure may be made thinner or thicker, e.g., shorter or taller, by using fewer or more unit cells, or larger or smaller unit cells, respectively, in the design of the lattice structure.

In an example embodiment, the lattice structure may be configured to correct certain movement of the foot of the user. For example, the lattice structure may be configured to correct pronation and/or supination, such as by designing the structure of the lattice in insole base layer 34 to be tilted towards the medial or lateral side. In an example embodiment, the lattice structure is designed to evenly distribute pressure from the foot across the entire insole.

In an example embodiment, corrective features are meant to correct anatomical or biomechanical problems with a user's foot. For example, a user may have a relatively high arch on one foot and a relatively low arch on the other, which creates support issues with regular footwear. As such, in an example embodiment, insoles described herein may include support underneath the high arch and the low arch in order to better distribute the user's weight in the footwear.

In an example embodiment, corrective features are meant to prevent injury rather than to correct an injury. For example, data can be collected when the user is performing a dynamic exercise (e.g., running) and used to determine the balance of a user's foot during movement. The determined balance may be compared to optimal balance data, which may be derived from other dynamic data or statistical data characterizing users who avoid injuries over long periods of time. Thus, corrective features may be designed into insole base layer 34 of the insole to provide better foot balance during movement in order to prevent injury.

In further example embodiments, corrective features may improve performance rather than correct an existing problem or prevent a potential problem. For example, it is known that characteristics of initial foot contact during running are related to running speed. Because of this, dynamic data may be collected to determine characteristics of a user's initial foot contact during running. Thus, an insole may be designed to change the user's initial foot contact to improve running speed and/or efficiency.

Corrective features may, for example, comprise areas of reduced or increased thickness in the lattice structure of insole base layer 34 of the insole. For example, an insole may have an area near the arch with increased thickness to provide additional support to the arch.

Corrective features may also comprise lattice geometry designed in a way to reduce tibial acceleration when running heel to toe by designing the heel and surrounding areas of insole base layer 34 to compress accordingly.

Corrective features may also comprise lattice geometry that enhances or inhibits bending of an insole in certain directions. The number, thickness, direction, and relative proximity of such corrective features may influence the propensity of the insole to bend in certain directions. Certain unit cells may be used in a particular functional zone in order to enhance the tendency for the insole to bend in a designed direction and to counteract the tendency to bend in an undesirable direction.

Furthermore, different materials can be used within the lattice geometry of the insole base layer 34 to inhibit bending, provide more support, and to achieve a certain compression response for that specific functional zone within insole base layer 34 of the insole, among other things. For example, if the user has plantar fasciitis and requires the insole to be more rigid in certain locations, then plastic and rubber may be used interchangeably while constructing the lattice geometry of insole base layer 34 to increase stiffness in certain areas.

Corrective features may also include the ability to design insoles that apply to each foot's individual support needs. This includes, but is not limited to, the shape, the pressure distribution, the required arch support, and the desired compression response at different locations of the user's foot, among other things.

Corrective features may also include one or more functional zones 40. These functional zones 40, in some example embodiments, may be formed out of or comprise unit cells. Functional zones 40 may influence the characteristics of an insole, such as the mechanical behavior of an insole.

Additionally, characteristics of connection points, such as a connection point 42 as shown in FIG. 4C, between functional zones 40 may also influence characteristics of an insole. For example, the thickness of a connection point may affect the mechanical properties of an insole. For example, the connection point 42 between functional zones 40A and 40PH may have a thickness different from the thickness of the lattice structures of functional zones 40A and 40PH as shown in FIG. 4C. In some instances, connection points can be, for example, selectively thickened or thinned in order to affect the way an insole reacts to different loads in different directions.

In some instances, the corrective features may be on the surface of an insole. For example, surface features such as textures, patterns, lines, or others as described above may be used to provide, for example, more grip, more feel, or more comfort, to a user of the custom footwear.

In some instances, one or more of the aforementioned corrective features may be arranged in functional zones 40 associated with an insole. Such functional zones 40 may be configured to influence different mechanical properties of an insole in different areas. In some instances, an insole may only have one functional zone 40, and in other instances an insole may include more than one functional zone.

In sum, the selection, arrangement, and physical characteristics of different corrective features in an insole may be used to correct or counteract a user's biomechanical issues, prevent injuries, and/or promote increased performance.

The technology disclosed herein thus encompasses improved insole designs and compositions and provides insoles that may be designed and tailored to each person's individual physiological data. The insoles may be designed with lattice geometry that comprises multiple load-compression profiles within the same monolithic part that can be mechanically tuned in order to individually and ideally support each of the user's feet while still allowing for breathability. Rigidity, stability, improved fit, and cushion may all be a part of the same, 3D printed, monolithic lattice structure.

The insoles described in various example embodiments and modes herein may comprise one or two layers, e.g., insole base layer 34 and (optionally) insole top layer 36. The insole base layer 34 may be comprised of a lattice structure with multiple functional zones 40 within a monolithic part and may be made using additive manufacturing techniques. In an example embodiment and mode, insole base layer 34 comprises an optional piece of material adhered to the top of the base layer and comes into contact with the bottom, and in some cases, a side of a user's foot.

The footwear 20 described herein and encompassed hereby may be beneficial for the treatment of a variety of known conditions related to the foot. For example, pronation in the foot (i.e., inward roll of the foot while standing, walking, and running) may lead to swelling and Achilles' tendon issues. To treat the pronation, footwear 20 may be designed to correct or improve the static and dynamic pressures on the foot. For example, the footwear 20 may correct support under the medial arch of the foot and may reduce the ability of the footwear to bend in certain directions. As another example, a bunion may be treated with footwear 20 designed to reduce medial load and provides customized support for the hallux (i.e., the big toe). Other conditions may also be treated using the footwear 20 described herein, such as: plantar fasciitis, arthritis, poor circulation, metatarsalgia, patellofemoral knee pain, shin splints, Achilles' tendonitis, repetitive strain injuries and others as are known by persons of skill in the art.

In various example embodiments and modes, a 3D printed insole may be designed to treat each foot separately allowing for optimal support for both feet. For example, it is common for someone to have different arch heights causing traditional “off-the-shelf” insoles to inadequately support both feet. 3D printed insoles may be designed to map the bottom of the user's feet individually and ideally, allowing for optimal support, compression control, and functionality for each individual foot, among other things.

In addition to treating existing, adverse foot conditions, the footwear 20 described herein may also help to prevent injuries and the onset of foot conditions. For example, custom footwear may reduce stress related injuries to the foot, ankle, leg, knee, back, etc. by better distributing the weight during the impact of footfalls, or by altering the way a foot falls and rotates during dynamic movements. Similarly, the footwear 20 described herein may prevent movement in certain directions (such as rolling ankle movement) while promoting movement in other directions (such as rolling of the forefoot during transitional movements).

Moreover, the footwear 20 described herein may improve biomechanical performance (e.g., for athletes). For example, the footwear 20 may alter the angle of impact of a foot during dynamic activities such as running, which in-turn may increase the overall speed of the runner.

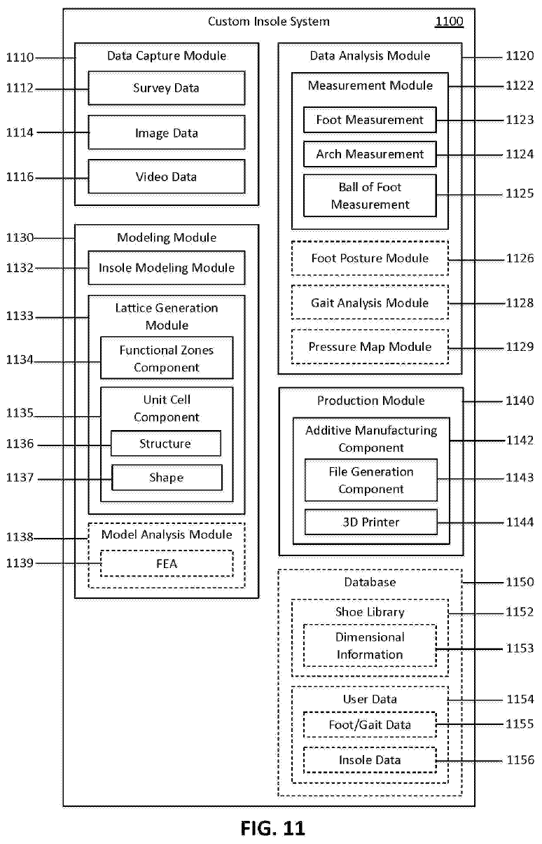

FIG. 11 is an example custom insole system 1100. The custom insole system 1100 includes one or more modules that receive, process, and analyze data related to a user of the custom insole, generate a model of the custom insole, and/or produce the custom insole. Portions of the system 1100 can be distributed across one or more hardware and/or software platforms that can communicate amongst each other to create a custom insole for a user. In other embodiments, the system 1100 and portions thereof can be collocated and/or one a single hardware and/or software platform, or combination thereof.

The system 1100 includes a data capture module 1110, a data analysis module 1120, a modeling module 1130, and a production module 1140. The system 1100 can also optionally include a database 1150 for storing data generated and/or used by the system 1100. Data regarding the user's foot or feet is captured by the data capture module 1110 and is analyzed by the data analysis module 1120 to determine various information regarding the user's foot or feet. Using the analysis of the captured data, the modeling module 1130 constructs a model of the custom insole for the user, which is then used by the production module 1140 to produce the physical insole for the user.

The data capture module 1110 can include survey data 1112 and image data 1114 capture capabilities and can also include video data 1116 capture capabilities, or combination(s) thereof. That is, the data capture module 1110 can assist with capturing and/or receiving survey data 1112, image data 1114, video data 1116, or combination(s) thereof. The captured and/or received data 1112, 1114, 1116, or combination thereof, can assist in the modeling of the insole. In an example embodiment, the data capture module 1110 can be integrated with a computer application, such as a web-based or mobile device application, to assist with capture of the data 1112, 1114, and/or 1116. In the example of a computer application, prompts or instructions can be provided to the user to assist with data capture by the data capture module 1110. For example, the user may be instructed to position an image capture device around their foot to capture various image data 1114. Example image capture devices can include a still or video camera, a camera-equipped smart phone or other mobile device, a webcam and/or other device(s) capable of capturing still and/or video image(s). The data captured by module 1110 can be optionally stored in database 1150, such as for a temporary, predetermined or indefinite period of time, and/or in accordance with a data capture/retention policy.

The survey data 1112 can include user provided responses or inputs to provided questions or prompts, such as may be provided to the user through the computer application. In an example embodiment, the survey data 1112 can include user inputs regarding various user information and the intended use for the custom insole. The user information can include data regarding the physical characteristics of the user, such as a height, weight, shoe size, or other user information. The intended use data can include information regarding the shoe the insole is intended to be worn with (e.g., brand/model), activities the user intends to engage with while using the insole, various pains or ailments the user is trying to relieve through use of the insole and/or other information regarding the use of the insole. The collected survey data 1112 can be used by the data analysis module 1120 and/or the modeling module 1130 to assist with determining the dimensions of the user's foot and with designing the custom insole.

Additionally, or alternatively, the survey data 1112 can include historical injury information regarding the user. Such information can be provided by the user and/or a medical professional assisting the user. The historical injury information of the user can be used to assist with the modeling of the insole, such that the insole is designed to prevent additional injury to the user. In this manner, the customized insole can be designed and constructed to assist in preventing injury to the user, while also including one or more performance features. This allows the user to benefit from both injury prevention and biomechanical advantage, as provided by the customized insole.

Image data 1114 and/or video data 1115 of the user's foot and a gait of the user is captured to assist with the design of the custom insole. As previously discussed, the user may be directed to aim or position an image capture device (e.g., camera, webcam, mobile device camera) to capture the image 1114 and/or video data 1115. In this manner, various image 1114 and/or video data 1115 of the user's foot or feet can be captured from various perspectives, such as side profile and top views of a user's foot. The captured image 1114 and/or video data 1115 can be used by the data analysis module 1120 to assist with determining and measuring various physical characteristics of the user's foot, feet and/or gait.

In an example embodiment, the user may be directed to capture video data 1115 of the user. Various physical landmarks of the user can be identified and tracked in the captured video to monitor and/or determine biomechanical movement of the user. By tracking the biomechanical movement of the user, various information regarding their gait, physical characteristics and/or movement characteristics can be determined or measured. For example, the hip alignment, stride length, foot posture, and/or other characteristics of the user can be measured and/or determined from the captured video data 1115. For example, the captured video data can include foot of the user walking and this can be used to assist with analysis of the user's gait. In another example, the user may be instructed to capture video data 1115 of the user's foot from a side profile perspective as the user steps or moves between seated and standing positions. Video data 1115 of the user's foot during loading and unloading, such as when walking or moving between seated and standing positions, can be used to assist with determining or analyzing a pressure distribution (e.g., a pressure map) of the user's foot. In some embodiments, a series of temporally spaced, captured images may be used in place of video data 1115.

The data capture module 1110 can also include a feedback component that can provide the user with feedback regarding the captured data 1112, 1114, 1116, such as to notify the user that additional data or new data is needed. For example, during the data capture process, image data 1114 can be analyzed to determine if the captured data is usable for the later analysis, such as based on the analyzed lighting conditions or other image criteria. The user may then be prompted to repeat the data capture process in order to obtain image data 1114 that is more usable during the analysis. The analysis to determine if the data, such as image data 1114, will be usable for later analysis can be performed on a user device that is capturing the data (e.g., a mobile device) or data can be transmitted to a remote server/system for analysis. In this manner, prompt or quick feedback can be provided to the user so that they do not later have to return to the data capture process.

The data analysis module 1120 analyzes and processes the captured data 1112, 1114, and/or 1116 of the data capture module 1110. Based on the captured data 1112, 1114, and/or 1116, the data analysis module 1120 can determine various characteristics or information regarding the user's foot using a measurement module 1122, a foot posture module 1126, a gait analysis module 1128 and/or a pressure map module 1129. Data from the data analysis module 1120 describes the user foot and various information or characteristics associated therewith, and this data is used by the modeling module 1130 to generate a model of the custom insole for the user.

The measurement module 1122 can analyze or use the survey data 1112, the image data 1114, video data 1116, or combinations thereof, to determine various measurement or dimensional data regarding the user's foot, such as a foot measurement 1123, arch measurement 1124, and a ball of the foot measurement 1125. In an example, to make such measurements, the measurement module 1122 can analyze image data 1114 of the user's foot. In the example, the data analysis module 1120 can have been trained, using machine learning, to identify various areas of interest of the user's foot, such as the overall length of the user's foot, the height of the user's foot, identifying the ball of the user's foot, identifying the heel of the user's foot and/or other features or characteristics of the user's foot.

Data from the data capture module 1110 can be processed by the data analysis module 1120 to generate physical, dimensional/measurement data regarding identified areas of interest. The identified areas of interest can be physical structures and/or characteristics of the user, such as of the user's foot. In an example, points of interest, such as anatomical features, can be automatically identified in the data from the data capture module 1110, such as from a photo or frame of a video. In such an example, machine learning can be used to assist in the automatic identification of the points of interest. A machine learning algorithm can be trained using a series of images with identified points of interest and/or manual corrections of automatic identifications of points of interest. Using these points of interest, various physical dimensions and/or measurements can be extracted, determined and/or generated from the data from the data capture module 1110 by the data analysis module 1120. In example such measurements can be based at least in part on a known or a provided measurement, such as based on information from the survey data 1112 and/or database 1150 data. Alternatively, features and/or properties of the captured data, such as properties of the photo or video and/or content therein, can be used to provide a reference measurement, or allow calculation or determination of a reference measurement, that can be used in determining or generating additional measurement data. This process can be replicated across various views of the user's foot (e.g., top view, opposite side view, etc.) to generate various dimensional measurements of the user's foot. Additionally, various dimensional relationships can also be used to determine the physical measurement(s) of features or characteristics of the user's foot. Alternatively, or additionally, the dimensional relationships can be used to cross check or validate the measurements determined by the measurement module 1122. The physical measurements determined by the measurement module 1122 can be used by the modeling module 1130 to assist with designing and modeling the custom insole to conform to the user's foot.

As part of the survey data 1112, an identification of a model of shoe that the user intends to use the customized insoles with can be identified. The database 1150 can include a shoe library 1152 that includes various information regarding different models of shoes. The information can include various physical characteristics of the shoe, such as a drop of the shoe and/or other parameters/characteristics of the shoe. The custom insole can include features to alter one or more of the various physical characteristics of the shoe, allowing the “feel” of the show to be further customized to the user. For example, the insole can be customized to alter the drop of the shoe from the inherent to a custom drop as specified by the user. This customization allows the user to further personalize the fit of their footwear using the customized insole.

The foot posture module 1126 can use images data 1114, video data 1116, or combination thereof, to assess the foot posture of the user, such as whether the user's foot over-pronates, supinates or is neutral in posture. In addition to identifying a foot posture of the user, the foot posture module 1126 can also assess the degree or extent of a user's foot posture. In an example, various image 1114, video data 1116, or combination thereof, representing various different views of the user's foot can be automatically assessed by the foot posture module 126, which has been trained for such analysis using machine-learning technique(s). The analysis can be based/trained on various trainings and studies correlating images of feet with various posture states. In addition to classifying the posture of the user's foot, the foot posture module 1126 can provide an assessment of the severity or degree of the foot posture classification. The foot posture information or analysis generated by the foot posture module 1126 can be used by the modeling module 1130 to assist with designing and modeling the custom insole for the user, such as to provide features to assist with correcting or accommodating the foot posture.

The gait analysis module 1128 can use video data 1116 to assess, categorize and/or classify the gait of the user. The user can be filmed walking and the gait analysis module can be trained, using machine learning, to identify relevant anatomy of the user within the video data 1116. The relevant anatomy can be tracked and the gait analysis module 1128 can determine if the user has various gait characteristics and can classify the degree or severity of such characteristics. The gait analysis by the gait analysis module 1128 can be used by the modeling module 1130 to assist with designing and modeling the custom insole for the user, and can be optionally stored and tracked over time for the user.

The pressure map module 1129 can use various data to assess, estimate or determine pressure distribution across a user's foot. This pressure data can assist with designing the custom insole for the user to better equally distribute the pressure across the surface area of the user's foot. In an example, the pressure map data 1129 can be obtained by a user standing or walking on a pressure-sensitive surface that generates data regarding the pressure exerted through the user's foot. In another example, image data 1114 and/or video data 1116 can be used to determine or estimate the pressure distribution across the user's foot. The pressure map module can process and analyze the image 1114 and/or video data 1116 to determine or estimate the pressure distribution based on the loading and unloading characteristics of the foot and/or how various features/characteristics of the foot deform during such loading and unloading processes. The pressure map data generated by the pressure map module 1129 can be used by the modeling module 1130 to assist with designing and modeling the custom insole for the user.

The modeling module 1130 uses the user foot data from the data analysis module 1120 to generate a model of the custom insole based on the specific characteristics, measurements and/or features of the user's foot and/or gait. The user foot data is used for designing the custom insole by assisting with the positioning of features and characteristics of the insole to correspond to the various characteristics, measurements and/or features of the user's foot. Additionally, the modeling module 1130 can use other data, such as survey data 1112, to assist with designing the custom insole.

An insole modeling module 1132 uses data from the data analysis module 1120, and optionally survey data 1112 and/or data from database 1150, to generate a solid model of the custom insole. The solid model is designed to conform to the various characteristics, measurements and/or features of the user's foot, and optionally the user's specified model shows that the insole will be used with. Additionally, the solid model generated by the insole modeling module 1132 can include features to assist with correcting, alleviating or remedying foot posture and/or gait issues. For example, a height of the arch of the insole model may be varied to reposition or reorient the user's foot on the insole to assist with correcting foot posture issues. In another embodiment, the features or characteristics of the solid model of the insole can be varied or adapted based on other data, such as survey data 1112 indicating the use cases for the insole. For example, the thickness of the insole may be increased to increase the cushioning capability of the insole or to better fill the interior space of the shoe when used with the user's foot. In alternative and/or further embodiments, other additional and/or alternative data or considerations can be used by the insole modeling module 1132 to assist with generating the solid model of the custom insole.

In other embodiments, the insole modeling module 1132 can include consideration of other orthotic features a user may wish to use in conjunction with their custom insole. In alternative embodiments, these other orthotic features can be integrated into the custom insole. The custom insole generated by the insole modeling module 1132 can take this into consideration and generate a custom insole module that accommodates and/or includes such additional orthotic feature(s). Examples of such additional orthotic features can include 1st ray cut-out, Morton's extension, reverse Morton's extension, metatarsal pad/bar, neuroma pad, heel lift, heel cup (depth), heelspur pad, donut pad, horseshoe pad, toe crest, arch placement, arch height and/or arch shape. In this manner, the insole can be further customized to the user and their needs and reduce the need for the user to utilize multiple orthotic devices and/or features.

In an example embodiment, a solid model of the user's foot can also be created based on data from the data analysis module 1120. The solid model of the user's foot can be used to assist with the generation of the insole model and/or to verify or check the insole model and its compatibility with the user's foot, such as verifying the features of the insole model align with features of the user's foot or that the features of the insole properly correct the posture of the user's foot.

A lattice generation module 1133 applies a lattice structure to the solid model of the custom insole that is generated by the insole modeling module 1132. The lattice generation module 1133 can include a functional zone component 1134 and unit cell component 1135. The functional zones component 1134 can use various information, such as survey data 1112 and data from the data analysis module 1120, to map various functional zones to areas of the insole model. The unit cell component 1135 can apply various unit cells to the insole model and to specific functional zones to achieve various characteristics of the insole, such as compression and rebound characteristics. The lattice structure can be applied to the entirety of the insole model or can be partially applied depending on the various insole characteristics that are needed or desired. Additionally, the lattice generation module 1133 can also use data regarding the material with which the insole is to be produced to assist with generating the lattice structure of the insole.

The functional zone component 1134 can use survey data 1112, such as the provided use case, remediation or alleviation data, and data from the data analysis module 1120 to determine various functional zones of the insole and their location. The functional zones of the insole are areas of the insole having differing compression and rebound characteristics. For example, a first functional zone can have first compression and rebound characteristics that differ from a second functional zone having second compression and rebound characteristics. In this manner, the compression and rebound characteristics of the insole are not uniform across the entirety of the insole. This allows the insole to be highly customized to the user's foot and their use case and/or issues they would like to remedy/alleviate.

The functional zone component 1134 can determine that the insole needs to be stiffer in certain areas and softer in other areas based on the survey data 1112 and the data from the data analysis module 1120. For example, under the areas of the foot that experience higher pressures, such as the ball of the foot, the functional zone component can define a functional zone corresponding to that area and specify that such an area be more resistant to compression. The lattice structure within that functional zone can be modified or adapted so that that area of the insole has the increased compression resistance characteristic. Similarly, the lattice structure within another functional zone can have increased rebound characteristics, such as to return more energy to the user after the lattice has been compressed. The increased rebound characteristics can enhance the performance characteristics of the insole, such as by assisting the user with pushing off from the ground during running or other activities. The ability to tune the insole using the functional zones allows the insole to be highly customized.

As previously discussed, the compression and rebound characteristics of each functional zone can be achieved by modifying the lattice structure, such as by modifying the unit cells or characteristics thereof within the functional zone. The unit cell component 1135 can apply and interconnect various unit cells within and across the insole model to create the lattice structure. The unit cells that are applied can have various structures 1136 and sizes 1137. The various structures 1136 can each have differing compression and rebound characteristics and the unit cell component 1135 can select a specific structure of the unit cells for use in a functional zone defined by the functional zone component 1134. The structure 1136 of the unit cells within the lattice can vary in order to achieve the compression and rebound characteristics for each of the functional zones identified or determined by the functional zone component 1134.

The unit cell component 1135 can select a unit cell type to use in the lattice structure from multiple types of unit cells. That is, the selected unit cell can have predetermined or preconfigured structure 1136 and/or size 1137 and used within the creation of the lattice structure. A library of unit cell types with various predetermined characteristics, such as structure 1136 and/or size 1137, can be maintained in a database, such as database 1150. The unit cell component 1135 can select the unit cell type based on one or more criteria, such as needed or desired mechanical characteristics of the unit cell type, the properties of the functional zone in which the unit cell will be positioned, etc.

In an alternative, the unit cell component 1135 can create or generate a unit cell for use in the lattice structure. The generated unit cell can have a structure 1136 and/or size 1137 that is determined and generated by the unit cell component 1135. The generation of the unit cell type can be based on a variety of criteria and/or considerations, such as needed or desired mechanical characteristics of the unit cell type, the properties of the functional zone in which the unit cell will be positioned, etc. The ability to generate a unit cell for use in the lattice structure allows for further customization of the insole for a particular user and/or use case. Additionally, once created, the generated unit cell can be stored and used in the creation of another lattice structure for an insole, such as storing the generated unit cell and its parameters/characteristics in a database.

The size 1137 of the unit cells can also be specified by the unit cell component 1133 based on the location of a specific unit cell within the lattice, such as its location within a specific functional zone. The varying sizes 1137 of each structure 1136 of a unit cell can have differing rebound and compression characteristics, providing further granularity for the unit cell component 1135 to position unit cells within the lattice to achieve the compression and rebound characteristics of the functional zone(s). Varying the size 1137 of the unit cell can include altering dimensions of members that form the unit cell, such as a thickness of the members. For example, the thickness of the members of the unit cell can be increased to increase the rigidity of the unit cell, increasing the resistance to compression of the unit cell. Further, the thickness of each of the members of a unit cell can be varied. This may provide directional control for the deformation of the unit cells, such as allowing the unit cells to resist compression better in one loading direction than another.

By controlling various parameters, such as structure 1136 and size 1137, of the unit cells within the lattice, the unit cell component 1135 can alter the compression and rebound characteristics of the insole. This allows the insole to have the various functional zones mapped/defined by the functional zone component 1134. In this manner, the lattice module 1133 can tune the lattice structure of the insole to achieve the various specifications of the user, such as by tuning the insole for the use case of the user (e.g., for performance or comfort).

An optional model analysis module 1138 can analyze the completed model of the insole and its lattice structure. Using data from the data capture module 1110 and/or the analysis module 1120, the completed lattice model of the insole can be tested. For example, the user's foot may be modeled as being applied to the latticed model of the insole to determine the compression and rebound response of the insole and/or how the insole distributes the applied pressure of the user's foot. This can serve as a verification of the latticed model of the insole prior to production.

The analysis of the latticed insole model can be done using finite element analysis (FEA) 1139 or other analysis processes. The use of FEA 1139 can illustrate the response of the latticed insole model to the applied forces by the user's foot. Additionally, this analysis may be performed in a dynamic nature, such as by modeling the walking or other activity of the user, to see the responsive characteristics of the insole.

The data generated by the model analysis module 1138 can also be used to iteratively refine the model and/or lattice structure of the insole. That is, based on the analysis, various features of the insole (e.g., shape, dimensions, arch height, arch position, etc.) and the lattice structure (e.g., functional zones, unit cells, etc.) may be modified. In this process of analysis and refinement, the structure of the insole may be better optimized for use by the user, which can further enhance the customization of the insole for the user. In an example, an ideal stress/strain curve(s) for the insole or portions thereof can be defined and the process of modeling the insole and the lattice structure can be repeated to refine the insole design to achieve or substantially match the specified, ideal stress/strain curve.

Additionally, the modeling module 1130 can also include a manufacturing analysis module that can analyze the latticed model of the insole based on various manufacturing considerations. Such analysis can assist with preventing manufacturing difficulties or problems prior to the actual manufacturing process of the custom insole. For example, the manufacturing analysis module can consider the capabilities of the additive manufacturing process and analyze the ability of the latticed insole to be produced using such a manufacturing process. The considerations can include the amount of time required to manufacture the custom insole, the amount of material used to manufacture the insole, determine a likelihood of successful manufacturing and/or other considerations. In an example embodiment, the latticed model of the insole can be analyzed for potential difficulties during the manufacturing process and this may cause the insole design to be modified to increase the likelihood of a successful manufacturing of the insole. In this manner, the manufacturing of the insole can be considered during the design phase to increase the manufacturing effectiveness and efficiency.

The production module 1140 can receive the latticed model of the insole from the modeling module 1130 to then manufacture or produce the physical insole for the user. The custom insole can be produced using an additive manufacturing process (e.g., 3D printing) by an additive manufacturing component 1142 of the production module 1140. The additive manufacturing component 1142 can include a file generation component 1143 and a 3D printer 1144. The latticed model of the custom insole can be processed by the file generation component 1143 to create the print file to be used by the 3D printer 1144. The file generation component 1143 can select an orientation for the model during printing and apply various support structures to support the insole print during the printing process. Various considerations, such as efficient use of the printing space, the materials usage and/or other considerations can be taken into account by the file generation component 1143 to assist with increasing the efficiency and effectiveness of the printing process.

Once generated, the print file can be sent to the 3D printer 1144 for production of the customized insole. In an example, the 3D printer 1144 can be an extrusion-type printer that heats and extrudes material in layers to create the latticed structure of the insole. Further, the material used to create the insole may be selected based on one or more considerations regarding the insole, such as use, the functional zones, or other considerations. In alternative embodiments, other 3D printers or techniques may also be used to create the custom insole. Once the insole is completed, it may then be provided to the user for their use.

The optional database 1150 can store various information for use in and generated by the custom insole creation process and users. In an example embodiment, database 1150 can include a shoe library 1152 and user data 1154. The shoe library 1152 can store dimensional information 1153 for various different shoe models. The dimensional information can include the interior dimensions of the shoe, dimensions of the standard insole for the shoe and/or other physical dimensions or measurements related to the stored models of shoes. The information can be provided by shoe manufactures or can be obtained by physical observation or measurement of various shoes. The shoe library 1152 can also store other information related to various models of shoes. The data from the shoe library 1512 can be recalled based on the survey data 1112 that includes an indication of the user's shoe model for which the insole will be used. The recalled shoe library 1152 data can then be used by the data analysis module 1120 and/or the modeling module 1130 to assist with generating the model of the custom insole for the user.

As previously mentioned, database 1150 can also store user data 1154. The user data 154 can include data regarding the user's foot/feet and gait 1155 and data regarding insoles designed for the user 156, such as data captured by the data capture module 1110, analysis performed by the data analysis module 1120, models generated by the modeling module 1130 and/or other user related data. This can allow the user data to be tracked over time to identify changes or lack thereof, such as worsening foot posture or gait, lack of improvement with user identified ailments, etc. In this manner, the effectiveness of previous custom insoles can be assessed and later versions can be further refined based on the tracked changes or lack thereof. Additionally, the tracking over time of such data can allow the system 1100 to provide notifications to the user of potential underlying physical health issues that may be reflected in the collected and stored user data 1154. Further, the user data 1154 can also be used to notify the user that it is likely time for the user to order another set of custom insoles based on their use case. The storage of user data 1154 can also allow additional insoles to be produced without the user having to provide some information or portions thereof (e.g., such as not having to provide image or video data again). Further, the system can request that the user provide such data again when the system 1100 determines that such data may no longer be relevant or accurate due to the age of the user data 1154.

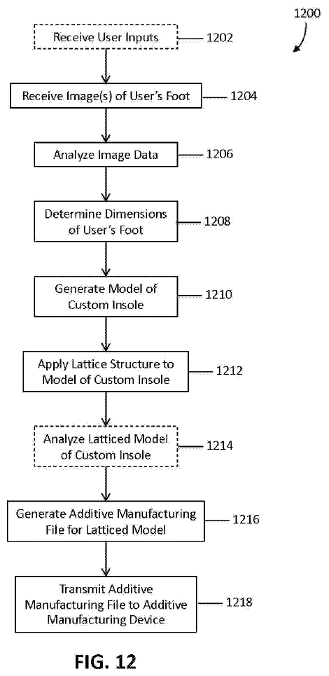

A method 1200 of designing and producing custom insoles is shown in FIG. 12. At 1202, user input(s) may be optionally received. The user input(s) can be provided in response to a survey or prompts for specific user information, such as shoes size, shoe model, anticipated use of the insole, ailments or concerns the user would like to remedy through use of the insole and/or other user information.

At 1204, images of a foot are received. The images are of a user's foot and the user may be provided instructions or prompts to assist with the capturing of the images. In a further embodiment, the received data can include video of the user's foot. The video may be in place of or in addition to the images.

At 1206, the image data is analyzed. The analysis of the image data can be done using machine learning trained computer vision techniques. In this manner a computer or computer system can receive and analyze the received images and identify points of interest, characteristics or features in each of the images based on the machine learning. For example, the computer system can be trained to identify specific anatomical features or dimensions of the user's foot in the images, such as an overall length of the user's foot, the arch of the user's foot, the ball of the user's foot, the heel of the user's foot and/or other features of the user's foot. In the example of received video data, individual video frames and/or composited video frames may be used as an image to which the analysis is applied.

At 1208, dimensions of the user's foot are determined based on the analyzed image data. The various features of the user's foot identified in the analysis at 1206 can be quantified or measured. In an example, a pixel to physical measurement scale for each image can be determined and this scale can be applied to the identified features of the user foot to generate physical dimensional data of such features. In an embodiment, the scale can be determined based on the identified number of pixels defining the length of the user's foot in an image, which can be correlated to a physical length or range of lengths based on the user input regarding their shoe size that was provided at 1202. Alternatively, the known and predictable dimensional relationships between features of feet can be used to derive physical dimension data of some features. In another alternative, a pixel to physical dimension scale may be derived from the image using various computations or algorithms. In yet another alternative, the user may be prompted to include a scale in the captured images of their foot and this scale can be used to determine physical dimensions of the user's foot based on the analyzed image data. Alternatively, the user may be prompted to provide the dimensional information directly or in addition to the images of their foot.

At 1210, a model of the insole is generated based on the dimensional data determined at 1208. The model can be a solid, 3D model of the insole. The modeled insole can include various features that complement the features of the user's foot, such as having a surface topography that matches that of the user's foot. Additionally, the model of the insole can include other dimensions, such as a thickness or depth of the insole. The thickness or depth of the insole can be determined based on one or more considerations, such as the comfort desired by the user, the use case for the insole, the type of shoe in which the insole will be placed and other considerations. For example, the insole may be made thicker to provide additional cushioning capability to the user or in cases where the user may be on their feet for extended periods of time. Similarly, the thickness of the insole may be reduced based on the shoe the insole will be inserted into, such as can be indicated by the user inputs at 1202. For example, if the user intends to place the insole in a dress shoe, the insole may need to be thinner than one that will be used in a hiking shoe due to the reduced interior space of the shoe to accommodate the insole and the user's foot.

At 1212, a lattice structure is applied to the insole model generated at 1210. The model generated at 1210 defines the volume of the insole and the lattice structure defines the internal structure of the insole. The lattice structure is made up of interconnected unit cells. Various parameters of the unit cells can be varied to achieve various characteristics of the insole, such as compression and rebound characteristics of the insole. In an example, the shape of the unit cells can be varied or selected, as can the size and/or dimensions of the unit cell, to achieve desired characteristics of the insole.

As part of applying the lattice structure at 1212, functional zones of the insole can also be defined. Functional zones are areas of the insole having specific or targeted characteristics. The functional zones may be based on user input provided at 1202 and/or the analyzed image data at 1204. The insole can include a number of functional zones that have varying characteristics, such as differing compression and rebound characteristics. To achieve these functional zones, the unit cell characteristics in the various functional zones can be varied or altered to better target or achieve the desired characteristics of the functional zone. In this manner, the custom insole can be designed or “tuned” or customized to specific, targeted characteristics for each individual user and their needs. For example, the lattice structure of the insole can be designed for a user experiencing pain and to assist with alleviating such pain. In another example, the lattice structure can be designed to assist with or improve the physical performance of the user. The lattice structure and its control allows the insole to be designed for such varied situations on an individual user basis.

At 1214, the latticed model of the insole can be optionally analyzed. In this process, various forces, such as those that replicate the forces exerted through the user's foot, can be applied to the latticed model and its performance can be assessed. The results of this analysis can be used to determine if the latticed insole model is adequate for the user or if further refinement is needed. Alternatively, or additionally, this analysis process can be used to iteratively refine the solid and/or latticed model of the insole to better optimize the insole for the specific user.

At 1216, an additive manufacturing file is generated for the insole. The latticed model of the insole can be analyzed and additive manufacturing instructions can be generated to cause an additive manufacturing device to construct the custom insole. As part of the file generation process, the manufacturability of the insole may be considered, such as a viability of the insole to be manufactured. In some examples, the latticed model may be too difficult to successfully create and further refinement may be necessary. Additionally, the file generation process can also select or determine various parameters of the additive manufacturing process, such as feed rate, print speeds, print orientation, support structures, etc.

At 1218, the additive manufacturing file generated at 1216 is transmitted or provided to an additive manufacturing device, such as a 3D printer. The additive manufacturing device uses the file to create the custom insole for the user. Once the insole is completed it can be provided to the user.

In generating and producing the custom insole, analysis of image and video data is used to assist with determining various features and characteristics of the user's foot. These various features and characteristics, such as various measurements, are used in generating the custom insole. The image and video data analysis can be an automated or partially automated process that uses machine learning to identify particular features of the user's foot or other anatomy that is present in the image and video data. The machine learning can train the analysis system and process with identifying particular features of user feet, such as the arch, length, height and other characteristics and features of feet. In the case of video analysis, the system can use the machine learning to track various anatomical features of the user as they move within the video data.

In an example, video data can be analyzed to track a user's gait. The user can provide video data of themselves walking, such as by being prompted to provide particular perspectives of the user walking. Using machine learning, the system can identify and track the motion of various anatomical features of the user, such as the motion of the user's foot, their leg, and other anatomical features. The system can analyze this information to determine relative measurements between the anatomical features, such as an angle of the user's leg relative to their foot. This analysis can assist with categorizing and classifying the gait of the user. This gait information can be used as part of the process of generating the insole so that the insole is designed to assist with correcting the user's gait or providing features that compensate for the user's gait.

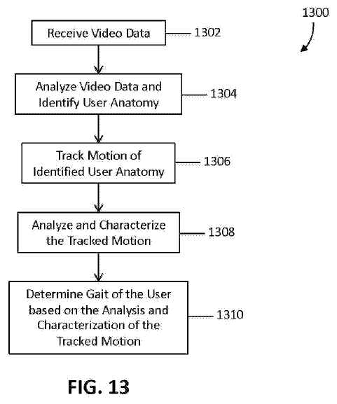

An example video analysis process 1300 is shown in FIG. 13. At 1302, video data is received. As previously discussed, the video data can include one or more video clips of the user walking from one or more perspectives. In an example embodiment, the user may be prompted or provided instructions regarding the capture of the provided video data.

At 1304, the video data can be analyzed and user anatomy within the video data can be identified, such as by use of machine-learned identification processes. Example anatomy that can be identified in the video clip can include an ankle joint, a leg, a foot and/or other anatomical features. At 1306, the motion of the identified anatomy of 1304 is tracked. The tracking can include tracking changes in the relative orientation between the identified anatomical features, such as how verticality of a user's leg changes while the user walks.

At 1308, the tracked motion of 1306 can be analyzed and characterized. The analysis and characterization can provide values that indicate various aspects or characteristics of the tracked motion. For example, the analysis can determine that the user's leg angles outward and the characterization can provide a value indicative of the degree at which the user's leg angles outward. Similarly, or alternatively, the motion of other tracked anatomical features of the user can be analyzed and characterized. In an example that includes multiple video clips from various perspectives, the analysis and characterization can be applied to each video clip and a comprehensive analysis and characterization can be determined from that of each of the individual video clips.

At 1310, the gait of the user can be determined based on the analysis and characterization at 1308. The gait can include a categorization and classification of the user's gait, such as that the user's gait indicates severe over-pronation. At 1312, optionally, a lattice structure of a custom insole can be generated based at least in part on the gait analysis at 1310. The lattice structure can be generated to correct or compensate for the gait of the user determined at 1310.

In another example, the loading and unloading of a user's foot can be analyzed to determine the deflection of various features of the user's foot. This data can also be used to assist with generating the custom insole by categorizing and classifying the data, which the insole can be designed to compensate for or correct. Additionally, or alternatively, this loading/unloading data of the user's foot can provide insight regarding the pressure distribution across the surface of the user's foot, which can also be considered when generating the insole so that the exerted pressure is more evenly distributed across the insole.

It will be appreciated by persons skilled in the art that numerous variations and/or modifications may be made to the invention without departing from the scope of the invention as broadly described. The above-described embodiments are, therefore, to be considered in all respects as illustrative and not restrictive.

Although the description above contains many specificities, these should not be construed as limiting the scope of the technology disclosed herein but as merely providing illustrations of some of the presently preferred embodiments of the technology disclosed herein. Thus, the scope of the technology disclosed herein should not be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each, and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A method of generating a custom insole structure, the method comprising:
receiving one or more images of a user's foot;
analyzing the one or more images of the user's foot to identify one or more points of interest of the user's foot;
automatically determining one or more dimensions of the user's foot based on the identified one or more points of interest of the user's foot;
generating a model of the custom insole structure based at least in part on the determined one or more dimensions of the user's foot; and
applying a lattice structure to the model of the custom insole based at least in part on the determined one or more dimensions of the user's foot; and
generating an additive manufacturing file base on the applied lattice structure to the model of the custom insole.

2. The method of claim 1, further comprising receiving user input and wherein one or more of determining the one or more dimensions of the user's foot, generating the model of the custom insole structure and applying the lattice structure to the model of the custom insole is based at least in part on the received user input.

3. The method of claim 2, wherein the user input comprises data regarding a user characteristic including one or more of a shoe size of the user, a weight of the user, and a height of the user.

4. The method of claim 2, wherein the user input comprises data regarding a use case of the user including one or more of an activity of the user, a shoe type of the user, historical injury information of the user, and a pain point of the user.

5. The method of claim 1, wherein receiving one or more images of a user's foot includes providing prompts to instruct a user to capture images of their foot.

6. The method of claim 1, further comprising determining a usability of the received one or more images of a user's foot based on an analysis of the received one or more images of a user's foot.

7. The method of claim 6, further comprising providing instruction to the user regarding capturing images of the user's foot based on determining that the usability of the received one or more images of a user's foot is not usable.

8. The method of claim 1, wherein receiving one or more images of a user's foot comprises receiving a series of captured images and automatically selecting one of the series of captured images based at least in part on analysis thereof.

9. The method of claim 1, wherein analyzing the one or more images of the user's foot to identify or more points of interest of the user's foot is performed automatically using a machine-learning model that is trained to identify the one or more points of interest.

10. The method of claim 9, wherein the one or more points of interest comprise one or more of a first and second extant point of the user's foot, a position of an arch of the user's foot, a position of a ball of a user's foot, and a position of a heel of a user's foot.

11. The method of claim 1, wherein automatically determining one or more dimensions of the user's foot based on the identified one or more points of interest of the user's foot is performed using a machine learning model that is trained to generate at least a measurement of a user's foot based on the identified one or more points of interest of the user's foot.

12. The method of claim 1, wherein automatically determining one or more dimensions of the user's foot based on the identified one or more points of interest of the user's foot is based at least in part on predetermined relationship between a first characteristic of a user's foot and a length of a user's foot.

13. The method of claim 1, wherein automatically determining one or more dimensions of the user's foot based on the identified one or more points of interest of the user's foot is based at least in part on analysis of a received one or more images of the user's foot.

14. The method of claim 2, wherein generating the model of the custom insole is further based at least in part on the received user input.

15. The method of claim 2, wherein applying the lattice structure to the model of the custom insole is further based at least in part on the received user input.

16. The method of claim 1, wherein applying the lattice structure to the model of the custom insole includes one or more of defining a functional zone and positioning of the functional zone.

17. The method of claim 16, further comprising at least one of selecting a unit cell of the lattice structure from a predetermined plurality of unit cells based on the functional zone or creating a unit cell of the.

18. The method of claim 16, wherein at least one characteristic of a first unit cell of the functional zone varies from a second unit cell of the lattice structure that is not part of the functional zone.

19. The method of claim 18, wherein the at least one characteristic of a first unit cell comprises one or more of a dimension of the unit cell, a dimension of one or more members of the unit cell, and a geometry of the members of the unit cell.

20. The method of claim 1, wherein generating the additive manufacturing file base on the applied lattice structure to the model of the custom insole comprises generating additive manufacturing device instructions based on the lattice structure and at least one of applying supports to the lattice structure or orienting the lattice structure for the additive manufacturing process.
